(19) United States
(12) Patent Application Publication
(10) Pub. No.: US 2010/0254251 A1
(43) Pub. Date: Oct. 7, 2010

(54) ARTICLES INVOLVING ENCAPSULATION OF HYGROSCOPIC MATERIALS

(75) Inventors: Sanjay Kumar, New Delhi (IN); Giriraj Nyati, New Delhi (IN); Subrata Dutta, New Delhi (IN); Rajeev Jindal, New Delhi (IN)

Correspondence Address: DAVID A. GUERRA;INTERNATIONAL PATENT GROUP, LLC, Suite 700, 1816 Crowchild Trail N.W., CALGARY, AB, T2M 3Y7, CA

(73) Assignee: MOSER BAER INDIA LIMITED, New Delhi (IN)

(21) Appl. No.: 12/557,720

(22) Filed: Sep. 11, 2009

(30) Foreign Application Priority Data
Apr. 1, 2009 (IN) 814/CHE/2009

(51) Int. Cl. G11B 7/26

(52) U.S. Cl. 369/283; 29/428; G9B/7.194

(57) ABSTRACT

An article involving encapsulation of one or more hygroscopic materials and manufacturing method and system thereof are provided. The article includes a first substrate, a second substrate, one or more first structures formed at a first periphery associated with the first substrate, and one or more second structures formed at a second periphery associated with the second substrate. The first structures and the second structures are engaged together mechanically to form an enclosure between the first substrate and the second substrate. The enclosure is capable of preventing exposure of a hygroscopic material encapsulated between the first substrate and the second substrate to the surrounding environment.

### CROSS-REFERENCE TO RELATED APPLICATION

This application claims the benefit of priority under 35 U.S.C 119 to co-pending India Patent Application No. 814/CHE/2009 filed on Apr. 1, 2009. The entire disclosure of the prior application is incorporated herein by reference.

### BACKGROUND OF THE INVENTION

1. Field of the Invention

The embodiments herein relate, in general, to encapsulation techniques. More particularly, the embodiments relate to articles involving encapsulation of one or more hygroscopic materials and manufacturing methods and systems thereof.

2. Description of the Prior Art

A holographic storage medium stores information within a photosensitive optical material. The photosensitive optical material is hygroscopic in nature, and gets damaged when exposed to the surrounding environment. This leads to loss of information stored on the holographic storage medium. Therefore, it is desired that such holographic storage media be protected against exposure to the surrounding environment.

With new developments in the photovoltaic industry, organic photovoltaic devices have been devised. In addition, various organic lighting devices have been devised recently. These organic photovoltaic devices and lighting devices employ hygroscopic materials. Therefore, it is desired that such organic photovoltaic devices and lighting devices be protected against exposure to the surrounding environment.

Various techniques have been employed for encapsulation of hygroscopic materials. In one such technique, a side wrap is wrapped around an outer edge of an article. The side wrap is then heat welded to seal the side wrap with the article. The side wrap may, for example, be made of a metal, a metal alloy, any non-metallic material that is capable of shielding the photosensitive optical material inside the article. In other techniques, a hermetic seal is applied on an outer edge of an article.

However, the above-mentioned techniques suffer from several disadvantages. Raw materials used in the side wrap are costly. In addition, the process is complex and time-consuming, and therefore, low-yielding. This leads to an increase in the cost of production. Moreover, the process may leave some micro-gaps in the side wrap. This makes the side wrap unreliable. Furthermore, such side wraps and seals add dead weight on articles.

In light of the foregoing discussion, there is a need for an article involving encapsulation of one or more hygroscopic materials that has a simple and reliable edge-closing structure, has a low cost, can be manufactured with higher yield in lesser time, and has a reduced dead weight, compared to conventional articles.

### SUMMARY OF THE INVENTION

In view of the foregoing disadvantages inherent in the known techniques now present in the prior art, the present invention overcomes the above-mentioned disadvantages and drawbacks of the prior art. As such, the general purpose of the present invention, which will be described subsequently in greater detail, is to provide new and improved articles involving encapsulation of hygroscopic materials and method which has all the advantages of the prior art mentioned heretofore and many novel features that result in articles involving encapsulation of hygroscopic materials which is not anticipated, rendered obvious, suggested, or even implied by the prior art, either alone or in any combination thereof.

An embodiment is to provide an article involving encapsulation of one or more hygroscopic materials (and manufacturing methods and systems thereof).

Another embodiment is to provide the article that has a simple and reliable edge-closing structure, compared to conventional articles.

Yet another embodiment is to provide the article that has a low cost, and can be manufactured with higher yield in lesser time, compared to conventional articles. In addition, the article should have a reduced dead weight, compared to conventional articles.

Embodiments herein provide an article involving encapsulation of one or more hygroscopic materials. The article includes a first substrate, a second substrate, one or more first structures at a first periphery associated with the first substrate, and one or more second structures at a second periphery associated with the second substrate. The first structures and the second structures substantially complement each other, and are capable of being engaged together mechanically to form an enclosure between the first substrate and the second substrate.

In accordance with an embodiment herein, the first structures include a plurality of first three-dimensional features protruding out from the first substrate along the first periphery, and the second structures include a plurality of second three-dimensional features protruding out from the second substrate along the second periphery. The first substrate is aligned with the second substrate, such that the first three-dimensional features and the second three-dimensional features are substantially engaged in an alternating manner.

In accordance with another embodiment herein, the first structures include one or more first threads on a first extension at the first periphery, and the second structures include one or more second threads on a second extension at the second periphery. The first substrate is aligned with the second substrate, and rotated relative to the second substrate, such that the first threads and the second threads close together.

The first structures and the second structures are simple in form, and can be engaged together to form the enclosure in a simple manner. Therefore, the article can be manufactured with higher yield in lesser time.

The enclosure so formed is reliable, and therefore, is capable of preventing exposure of a hygroscopic material encapsulated between the first substrate and the second substrate to the surrounding environment.

Moreover, no additional material is required to be applied to form the enclosure. Therefore, the article has a reduced dead weight, and has a low cost.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1A illustrates a top view of an article of manufacture involving encapsulation of one or more hygroscopic materials, and FIG. 1B illustrates a sectional view of a section A-A cut through the article, in accordance with an embodiment herein;

FIG. 2A illustrates a top view of an article of manufacture involving encapsulation of one or more hygroscopic materials, and FIG. 2B illustrates a sectional view of a section B-B cut through the article, in accordance with an exemplary embodiment herein;

FIGS. 3A and 3B illustrate how an enclosure is formed, and FIG. 3C is an enlarged view illustrating two first three-dimensional features and a second three-dimensional feature, in accordance with a first exemplary embodiment herein;

FIGS. 4A and 4B illustrate how an enclosure is formed, in accordance with a second exemplary embodiment herein;

FIGS. 5A and 5B illustrate how an enclosure is formed, in accordance with a third exemplary embodiment herein;

FIGS. 6A and 6B illustrate how an enclosure is formed, in accordance with a fourth exemplary embodiment herein;

FIG. 7A illustrates a top view of an article of manufacture involving encapsulation of one or more hygroscopic materials, and FIG. 7B illustrates a sectional view of a section C-C cut through the article, in accordance with another embodiment herein;

FIGS. 8A and 8B are sectional views illustrating how an enclosure is formed, in accordance with a fifth exemplary embodiment herein;

FIGS. 9A and 9B are sectional views illustrating how an enclosure is formed, in accordance with a sixth exemplary embodiment herein;

FIG. 10 illustrates a system for manufacturing an article involving encapsulation of one or more hygroscopic materials, in accordance with an embodiment herein;

FIG. 11 illustrates a system for manufacturing an article involving encapsulation of one or more hygroscopic materials, in accordance with another embodiment herein;

FIG. 12 illustrates a system for manufacturing an article involving encapsulation of one or more hygroscopic materials, in accordance with yet another embodiment herein;

FIG. 13 illustrates a method of manufacturing an article involving encapsulation of one or more hygroscopic materials, in accordance with an embodiment herein;

FIG. 14 illustrates a method of manufacturing an article involving encapsulation of one or more hygroscopic materials, in accordance with another embodiment herein;

FIG. 15 illustrates a method of manufacturing an article involving encapsulation of one or more hygroscopic materials, in accordance with yet another embodiment herein;

FIG. 16 illustrates a method of manufacturing a storage medium, in accordance with an embodiment herein;

FIG. 17 illustrates a method of manufacturing a storage medium, in accordance with another embodiment herein;

FIG. 18 illustrates a method of manufacturing a storage medium, in accordance with yet another embodiment herein;

FIG. 19 illustrates a method of manufacturing a photovoltaic cell, in accordance with an embodiment herein; and

FIG. 20 illustrates a method of manufacturing a lighting device, in accordance with an embodiment herein.

The same reference numerals refer to the same parts throughout the various figures.

### DESCRIPTION OF THE PREFERRED EMBODIMENT

As used in the specification and claims, the singular forms “a”, “an” and “the” include plural references unless the context clearly dictates otherwise. For example, the term “an article” may include a plurality of articles unless the context clearly dictates otherwise.

Embodiments herein provide an article of manufacture involving encapsulation of one or more hygroscopic materials, and a method and system for manufacturing the article. In the description of the embodiments herein, numerous specific details are provided, such as examples of components and/or mechanisms, to provide a thorough understanding of embodiments herein. One skilled in the relevant art will recognize, however, that an embodiment herein can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments herein.

Glossary

First substrate and second substrate: A first substrate and a second substrate encapsulate a hygroscopic material in-between.

First periphery and second periphery: A periphery of a region includes a boundary of that region. In certain embodiments herein, the periphery may also include a narrow area in proximity to the boundary of the region. A first periphery is associated with the first substrate, while a second periphery is associated with the second substrate.

First structure, second structure and enclosure: One or more first structures and one or more second structures are formed at the first periphery and the second periphery, respectively. The first structures and the second structures substantially complement each other. The first structures and the second structures are engaged together mechanically to form an enclosure between the first substrate and the second substrate.

Three-dimensional features: Three-dimensional features are a sequence of individual three-dimensional features arranged one after another. These three-dimensional features protrude out from a substrate. The three-dimensional features may be of any desired shape. For example, the three-dimensional features may be polygonal or curved in shape.

Threads: A thread is a three-dimensional spiral rib that is formed on an extension at a periphery.

First molding unit: A first molding unit molds a first substrate with one or more first structures. The first molding unit may, for example, be an injection molding machine.

First three-dimensional mold: A first three-dimensional mold is designed to form a plurality of first three-dimensional features on the first substrate. The first three-dimensional mold may, for example, include a stamper with a negative impression of the first three-dimensional features to be formed.

First thread mold: A first thread mold is designed to form one or more first threads on the first substrate. The first thread mold may, for example, include a stamperwith a negative impression of the first threads to be formed.

Second molding unit: A second molding unit molds a second substrate with one or more second structures. The second molding unit may, for example, be an injection molding machine.

Second three-dimensional mold: A second three-dimensional mold is designed to form a plurality of second three-dimensional features on the second substrate. The second three-dimensional mold may, for example, include a stamper with a negative impression of the second three-dimensional features to be formed.

Second thread mold: A second thread mold is designed to form one or more second threads on the second substrate. The second thread mold may, for example, include a stamper with a negative impression of the second threads to be formed.

Engaging unit: An engaging unit engages the first structures and the second structures together mechanically to form an enclosure.

Aligning unit: An aligning unit aligns the first substrate and the second substrate. For example, the aligning unit may pick the first substrate and align the first substrate with the second substrate.

Rotating unit: A rotating unit rotates the first substrate and the second substrate relative to each other.

Photovoltaic cell: A photovoltaic cell is a packaged assembly of photovoltaic elements, which converts solar energy into electricity by the photovoltaic effect.

Lighting device: A lighting device is a packaged assembly of light-emitting elements, which is often used for display.

The article includes a first substrate, a second substrate, one or more first structures at a first periphery, and one or more second structures at a second periphery. The first periphery is associated with the first substrate, while the second periphery is associated with the second substrate. The first structures and the second structures substantially complement each other, and are capable of being engaged together mechanically to form an enclosure between the first substrate and the second substrate.

In accordance with an embodiment herein, the first structures include a plurality of first three-dimensional features protruding out from the first substrate along the first periphery in a sequence, and the second structures include a plurality of second three-dimensional features protruding out from the second substrate along the second periphery in a sequence. In order to form the enclosure, the first substrate is aligned with the second substrate, such that the first three-dimensional features and the second three-dimensional features are substantially engaged in an alternating manner.

The first three-dimensional features have a shape that is substantially complementary to the shape of the second three-dimensional features. The first three-dimensional features and the second three-dimensional features may, for example, have a polygonal shape, such as a rectangular shape, a trapezoidal shape and a triangular shape. The first three-dimensional features and the second three-dimensional features may also have a curved shape, such as a U shape and a bell shape.

In accordance with another embodiment herein, the first structures include one or more first threads on a first extension at the first periphery, and the second structures include one or more second threads on a second extension at the second periphery. The first threads and the second threads substantially complement each other. The first substrate is aligned with the second substrate, and rotated relative to the second substrate, such that the first threads and the second threads close together. The first substrate may, for example, be rotated at an angle of rotation ranging between 10 degrees and 360 degrees, to form the enclosure.

The enclosure so formed is capable of preventing exposure of a hygroscopic material encapsulated between the first substrate and the second substrate to the surrounding environment. This makes the article suitable for various applications. In one embodiment herein, the article may be suitably used in a holographic storage medium, wherein a storage material, including a hygroscopic material, is dispensed between the first substrate and the second substrate. In another embodiment herein, the article may be suitably used in an organic photovoltaic cell, wherein one or more photovoltaic elements, including a hygroscopic material, are placed between the first substrate and the second substrate. In yet another embodiment herein, the article may be suitably used in an organic lighting device, wherein one or more light-emitting elements, including a hygroscopic material, are placed between the first substrate and the second substrate.

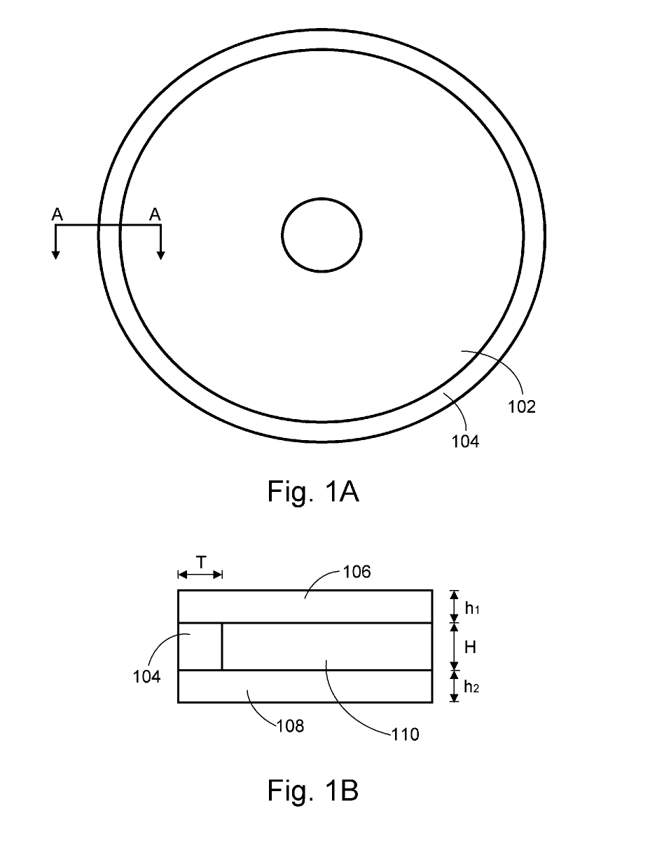

FIG. 1A illustrates a top view of an article of manufacture 102 involving encapsulation of one or more hygroscopic materials, in accordance with an embodiment herein. Article 102 has an enclosure 104 formed at its periphery.

FIG. 1B illustrates a sectional view of a section A-A cut through article 102, in accordance with an embodiment herein. Article 102 includes a first substrate 106, a second substrate 108, one or more first structures (not shown in FIGS. 1A-1B) formed at a first periphery associated with first substrate 106, and one or more second structures (not shown in FIGS. 1A-1B) formed at a second periphery associated with second substrate 108. The first structures and the second structures substantially complement each other. The first structures and the second structures are capable of being engaged together mechanically to form enclosure 104 between first substrate 106 and second substrate 108.

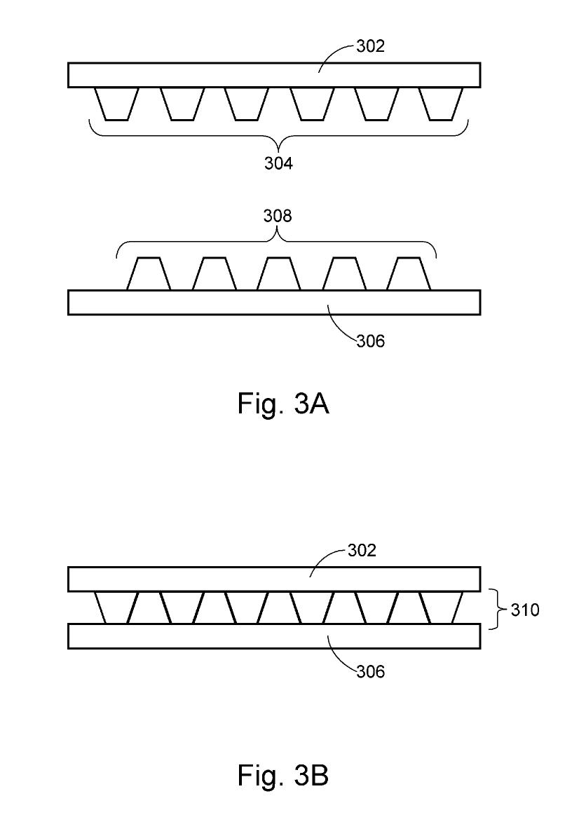

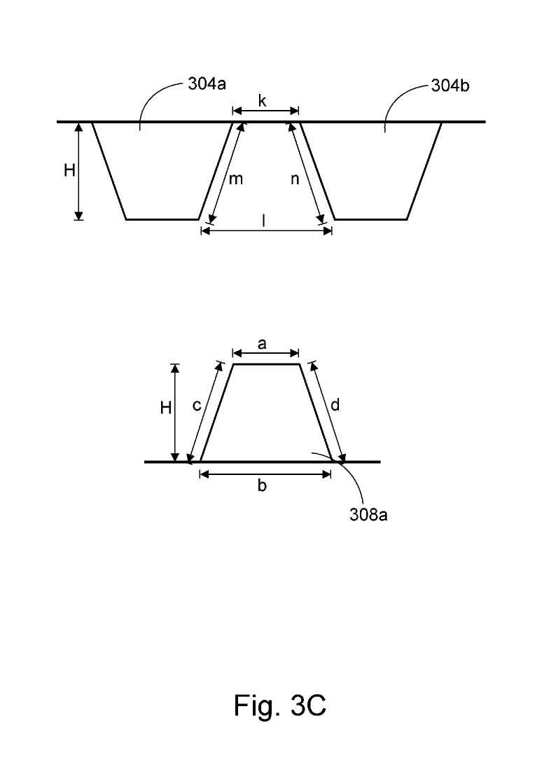

In accordance with an embodiment herein, the first structures include a plurality of first three-dimensional features protruding out from first substrate 106 along the first periphery in a sequence, and the second structures include a plurality of second three-dimensional features protruding out from second substrate 108 along the second periphery in a sequence. The first three-dimensional features have a shape that is substantially complementary to the shape of the second three-dimensional features. In order to form enclosure 104, first substrate 106 is aligned with second substrate 108, such that the first three-dimensional features and the second three-dimensional features are substantially engaged in an alternating manner. Details of such three-dimensional features have been provided in conjunction with FIGS. 3A-3C, 4A-4B, 5A-5B, and 6A-6B.

With reference to FIG. 1B, first substrate 106 has a height ‘h1’ and second substrate 108 has a height ‘h2’. The values of ‘h1’ and ‘h2’ may, for example, range between 0.5 mm and 1.5 mm. Enclosure 104 has a thickness ‘T’ and a height ‘H’. The value of ‘T’ may, for example, range between 0.5 mm and 2 mm, while the value of ‘H’ may, for example, range between 0.5 mm and 2 mm.

A three-dimensional space 110 of height ‘H’ is formed between first substrate 106 and second substrate 108. A hygroscopic material is filled in three-dimensional space 110. While the hygroscopic material is encapsulated between first substrate 106 and second substrate 108, enclosure 104 prevents exposure of the hygroscopic material to the surrounding environment.

With reference to FIG. 1A, article 102 is circular in shape. Accordingly, first substrate 106 and second substrate 108 are circular in shape. It should be noted here that article 102 is not limited to a specific shape or size of its components. FIGS. 1A and 1B are merely an example, which should not unduly limit the scope of the claims herein. One of ordinary skill in the art would recognize many variations, alternatives, and modifications of embodiments herein.

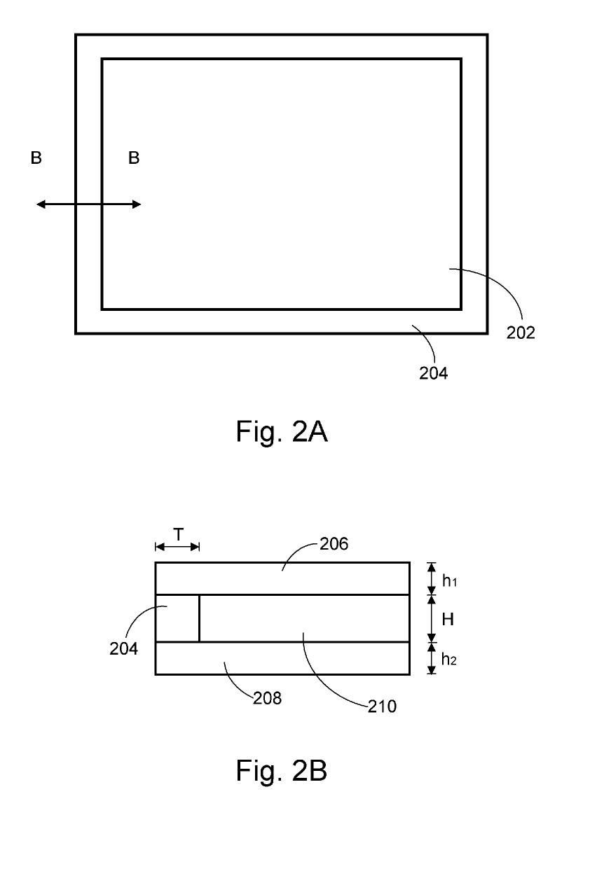

FIG. 2A illustrates a top view of an article of manufacture 202 involving encapsulation of one or more hygroscopic materials, and FIG. 2B illustrates a sectional view of a section B-B cut through article 202, in accordance with an exemplary embodiment herein. With reference to FIG. 2A, article 202 is rectangular in shape.

Article 202 includes a first substrate 206, a second substrate 208, one or more first structures (not shown in FIGS. 2A-2B) formed at a first periphery associated with first substrate 206, and one or more second structures (not shown in FIGS. 2A-2B) formed at a second periphery associated with second substrate 208. The first structures and the second structures substantially complement each other. The first structures and the second structures are capable of being engaged together mechanically to form an enclosure 204 between first substrate 206 and second substrate 208.

As mentioned above, the first structures include a plurality of first three-dimensional features protruding out from first substrate 206 along the first periphery in a sequence, and the second structures include a plurality of second three-dimensional features protruding out from second substrate 208 along the second periphery in a sequence, in accordance with an embodiment herein. The first three-dimensional features have a shape that is substantially complementary to the shape of the second three-dimensional features. First substrate 206 is aligned with second substrate 208, such that the first three-dimensional features and the second three-dimensional features are substantially engaged in an alternating manner. Details of such three-dimensional features have been provided in conjunction with FIGS. 3A-3C, 4A-4B, 5A-5B, and 6A-6B.

With reference to FIG. 2B, first substrate 206 has a height ‘h1’ and second substrate 208 has a height ‘h2’. The values of ‘h1’ and ‘h2’ may, for example, range between 0.5 mm and 1.5 mm. Enclosure 204 has a thickness ‘T’ and a height ‘H’. The value of ‘T’ may, for example, range between 0.5 mm and 2 mm, while the value of ‘H’ may, for example, range between 0.5 mm and 2 mm.

A three-dimensional space 210 of height ‘H’ is formed between first substrate 206 and second substrate 208. Enclosure 204 prevents exposure of a hygroscopic material filled in three-dimensional space 210 to the surrounding environment.

FIGS. 3A and 3B illustrate how an enclosure is formed, in accordance with a first exemplary embodiment herein. A first substrate 302 includes a plurality of first three-dimensional features 304 protruding out along a first periphery. A second substrate 306 includes a plurality of second three-dimensional features 308 protruding out along a second periphery.

First three-dimensional features 304 are arranged in a sequence one after another, as shown in FIG. 3A. Similarly, second three-dimensional features 308 are arranged in a sequence one after another. With reference to FIG. 3A, first three-dimensional features 304 and second three-dimensional features 308 are trapezoidal in shape. It should be noted here that first three-dimensional features 304 and second three-dimensional features 308 may be in the form of one or more rows of trapezoidal three-dimensional features.

First three-dimensional features 304 are formed in a manner that a gap between two adjacent first three-dimensional features 304 substantially complements a second three-dimensional feature 308. Therefore, first three-dimensional features 304 and second three-dimensional features 308 substantially engage in an alternating manner, to form a substantially closed enclosure 310, as shown in FIG. 3B.

FIG. 3C is an enlarged view illustrating two first three-dimensional features 304a and 304b, and a second three-dimensional feature 308a, in accordance with a first exemplary embodiment herein. With reference to FIG. 3C, first three-dimensional feature 304a, first three-dimensional feature 304b and second three-dimensional feature 308a have the same height ‘H’. Two parallel sides of second three-dimensional feature 308a have lengths ‘a’ and ‘b’, while two inclined sides of second three-dimensional feature 308a have lengths ‘c’ and ‘d’. First three-dimensional features 304a and 304b are formed in a manner that a gap between first three-dimensional features 304a and 304b substantially complements second three-dimensional feature 308a. Accordingly, the value of ‘k’ is substantially equal to the value of ‘a’, the value of ‘I’ is substantially equal to the value of ‘b’, the value of ‘m’ is substantially equal to the value of ‘c’, and the value of ‘n’ is substantially equal to the value of ‘d’. Therefore, when first three-dimensional features 304 are mechanically engaged with second three-dimensional features 308, a substantially closed enclosure is formed. This holds true for other three-dimensional features as well, regardless of their shapes.

It should be noted that a three-dimensional feature may have any desired dimensions. Continuing from the above example, the value of ‘a’ may be greater or lesser than, or equal to the value of ‘b’.

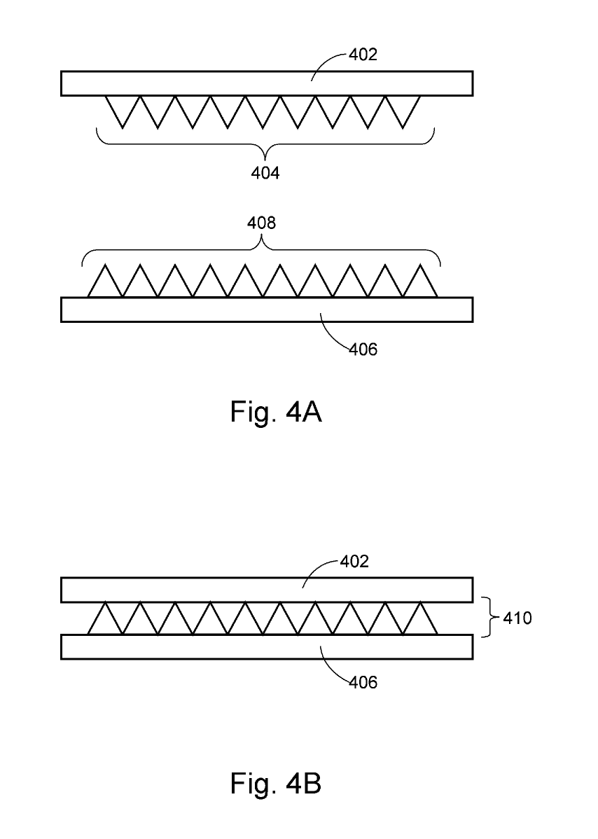

FIGS. 4A and 4B illustrate how an enclosure is formed, in accordance with a second exemplary embodiment herein. A first substrate 402 includes a plurality of first three-dimensional features 404 protruding out along a first periphery, while a second substrate 406 includes a plurality of second three-dimensional features 408 protruding out along a second periphery.

First three-dimensional features 404 are arranged in a sequence one after another, as shown in FIG. 4A. Similarly, second three-dimensional features 408 are arranged in a sequence one after another. With reference to FIG. 4A, first three-dimensional features 404 and second three-dimensional features 408 are triangular in shape. It should be noted here that first three-dimensional features 404 and second three-dimensional features 408 may be in the form of one or more rows of triangular three-dimensional features.

First three-dimensional features 404 are formed in a manner that a gap between two adjacent first three-dimensional features 404 substantially complements a second three-dimensional feature 408. Therefore, first three-dimensional features 404 and second three-dimensional features 408 substantially engage in an alternating manner, to form a substantially closed enclosure 410, as shown in FIG. 4B.

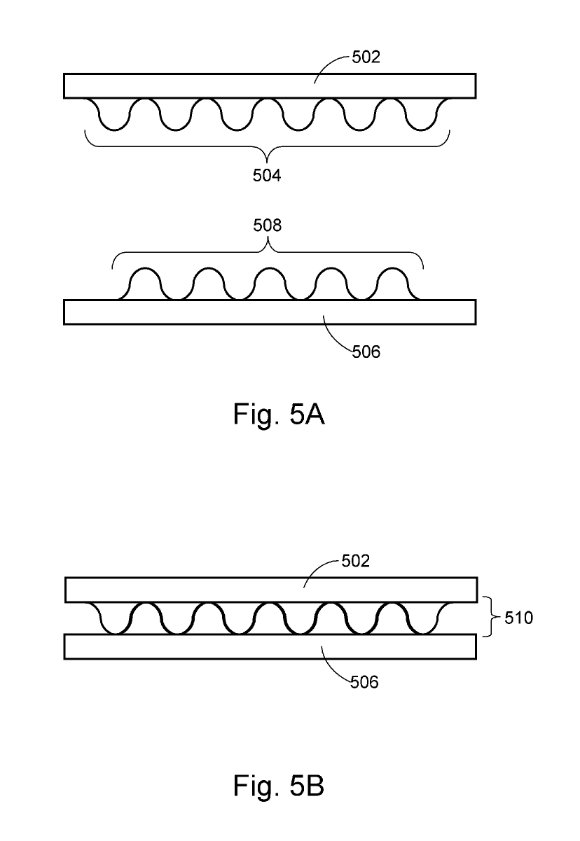

FIGS. 5A and 5B illustrate how an enclosure is formed, in accordance with a third exemplary embodiment herein. A first substrate 502 includes a plurality of first three-dimensional features 504 protruding out along a first periphery, while a second substrate 506 includes a plurality of second three-dimensional features 508 protruding out along a second periphery.

First three-dimensional features 504 are arranged in a sequence one after another, as shown in FIG. 5A. Similarly, second three-dimensional features 508 are arranged in a sequence one after another. With reference to FIG. 5A, first three-dimensional features 504 and second three-dimensional features 508 are bell-shaped. It should be noted here that first three-dimensional features 504 and second three-dimensional features 508 may be in the form of one or more rows of bell-shaped three-dimensional features.

First three-dimensional features 504 are formed in a manner that a gap between two adjacent first three-dimensional features 504 substantially complements a second three-dimensional feature 508. Therefore, first three-dimensional features 504 and second three-dimensional features 508 substantially engage in an alternating manner, to form a substantially closed enclosure 510, as shown in FIG. 5B.

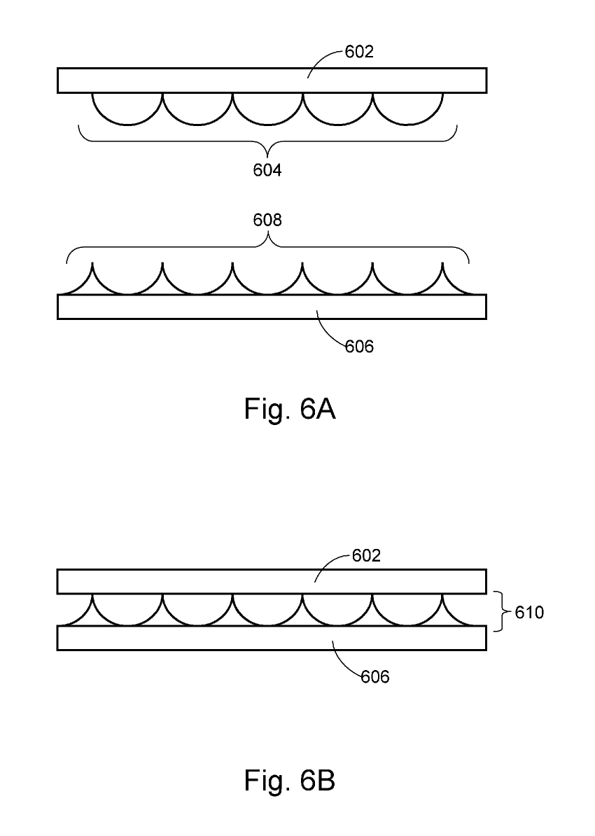

FIGS. 6A and 6B illustrate how an enclosure is formed, in accordance with a fourth exemplary embodiment herein. A first substrate 602 includes a plurality of first three-dimensional features 604 protruding out along a first periphery, while a second substrate 606 includes a plurality of second three-dimensional features 608 protruding out along a second periphery.

First three-dimensional features 604 are arranged in a sequence one after another, as shown in FIG. 6A. Similarly, second three-dimensional features 608 are arranged in a sequence one after another. With reference to FIG. 6A, first three-dimensional features 604 are U-shaped, while second three-dimensional features 608 have a hollow-U shape, substantially complementary to the shape of first three-dimensional features 604. It should be noted here that first three-dimensional features 604 and second three-dimensional features 608 may be in the form of one or more rows of U-shaped three-dimensional features and hollow-U-shaped three-dimensional features, respectively.

First three-dimensional features 604 are formed in a manner that a gap between two adjacent first three-dimensional features 604 substantially complements a second three-dimensional feature 608. Therefore, first three-dimensional features 604 and second three-dimensional features 608 substantially engage in an alternating manner, to form a substantially closed enclosure 610, as shown in FIG. 6B.

FIGS. 3A-3C, 4A-4B, 5A-5B and 6A-6B are merely examples, which should not unduly limit the scope of the claims herein. One of ordinary skill in the art would recognize many variations, alternatives, and modifications of embodiments herein.

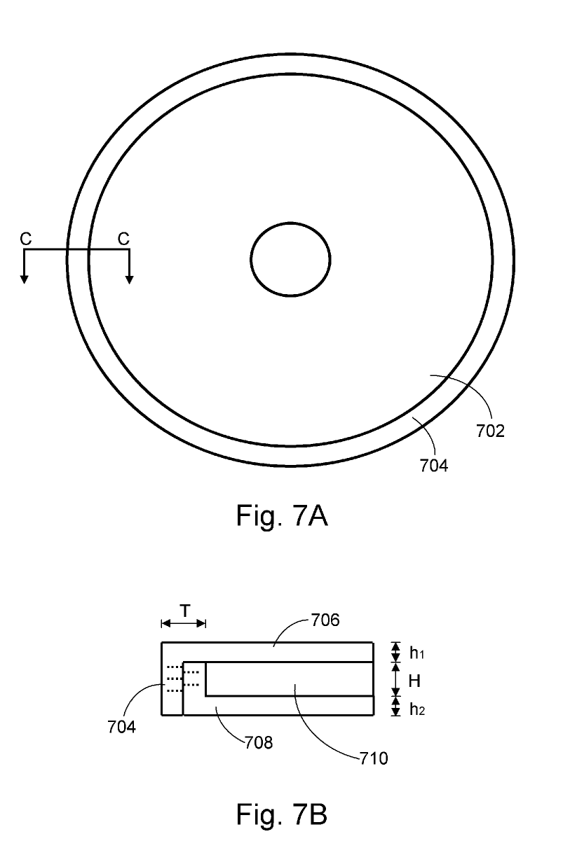

FIG. 7A illustrates a top view of an article of manufacture 702 involving encapsulation of one or more hygroscopic materials, in accordance with another embodiment herein. Article 702 has an enclosure 704 formed at its periphery.

FIG. 7B illustrates a sectional view of a section C-C cut through article 702, in accordance with another embodiment herein. Article 702 includes a first substrate 706, a second substrate 708, one or more first structures (not shown in FIGS. 7A-7B) formed at a first periphery associated with first substrate 706, and one or more second structures (not shown in FIGS. 7A-7B) formed at a second periphery associated with second substrate 708. The first structures and the second structures substantially complement each other. The first structures and the second structures are capable of being engaged together mechanically to form enclosure 704 between first substrate 706 and second substrate 708.

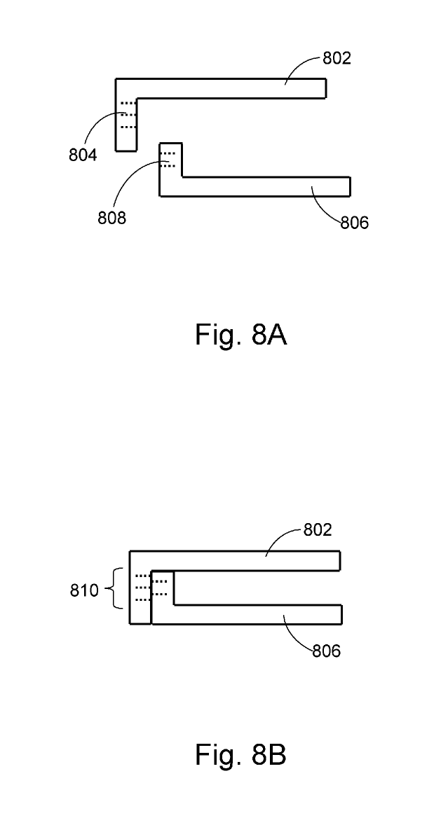

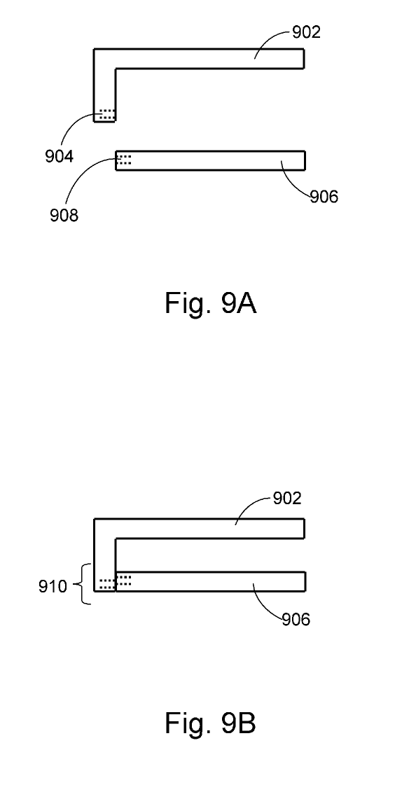

In accordance with another embodiment herein, the first structures include one or more first threads on a first extension at the first periphery, and the second structures include one or more second threads on a second extension at the second periphery. First substrate 706 is aligned with second substrate 708, and rotated relative to second substrate 708, such that the first threads and the second threads close together. For example, first substrate 706 and second substrate 708 may be rotated relative to each other at an angle of rotation ranging between 10 degrees and 360 degrees, to form enclosure 704. Details of such threads have been provided in conjunction with FIGS. 8A-8B and 9A-9B.

With reference to FIG. 7B, first substrate 706 has a height ‘h1’ and second substrate 708 has a height ‘h2’. The values of ‘h1’ and ‘h2’ may, for example, range between 0.5 mm and 1.5 mm. Enclosure 704 has a thickness ‘T’ and a height ‘H’. The value of ‘T’ may, for example, range between 0.5 mm and 2 mm, while the value of ‘H’ may, for example, range between 0.5 mm and 2 mm.

A three-dimensional space 710 of height ‘H’ is formed between first substrate 706 and second substrate 708. A hygroscopic material is filled in three-dimensional space 710. While the hygroscopic material is encapsulated between first substrate 706 and second substrate 708, enclosure 704 prevents exposure of the hygroscopic material to the surrounding environment.

With reference to FIG. 7A, article 702 is circular in shape. Accordingly, first substrate 706 and second substrate 708 are circular in shape. It should be noted here that article 702 is not limited to a specific shape or size of its components. FIGS. 7A and 7B are merely an example, which should not unduly limit the scope of the claims herein. One of ordinary skill in the art would recognize many variations, alternatives, and modifications of embodiments herein.

FIGS. 8A and 8B are sectional views illustrating how an enclosure is formed, in accordance with a fifth exemplary embodiment herein. A first substrate 802 includes one or more first threads 804 on a first extension at a first periphery, while a second substrate 806 includes one or more second threads 808 on a second extension at a second periphery. With reference to FIG. 8A, first threads 804 are formed on an inner side of an L-shaped extension on first substrate 802, and second threads 808 are formed on an outer side of an L-shaped extension on second substrate 806.

First substrate 802 is aligned with second substrate 806. First substrate 802 is then rotated relative to second substrate 806, such that first threads 804 and second threads 808 close together to form an enclosure 810, as shown in FIG. 8B.

FIGS. 8A and 8B are merely an example, which should not unduly limit the scope of the claims herein. One of ordinary skill in the art would recognize many variations, alternatives, and modifications of embodiments herein. For example, the arrangement of first substrate 802 and second substrate 806 may be interchanged, that is, second substrate 806 may be arranged over first substrate 802. In other words, the design of first substrate 802 and second substrate 806 may be interchanged, that is, first threads 804 may be formed on an outer side of the L-shaped extension on first substrate 802, and second threads 808 may be formed on an inner side of the L-shaped extension on second substrate 806.

FIGS. 9A and 9B are sectional views illustrating how an enclosure is formed, in accordance with a sixth exemplary embodiment herein. A first substrate 902 includes one or more first threads 904 on a first extension at a first periphery, while a second substrate 906 includes one or more second threads 908 on a second extension at a second periphery. With reference to FIG. 9A, first threads 904 are formed on an inner side of an L-shaped extension on first substrate 902, and second threads 908 are formed on a vertical edge of second substrate 906.

First substrate 902 is aligned with second substrate 906, and rotated relative to second substrate 906. Consequently, first threads 904 and second threads 908 close together to form an enclosure 910, as shown in FIG. 9B.

FIGS. 9A and 9B are merely an example, which should not unduly limit the scope of the claims herein. One of ordinary skill in the art would recognize many variations, alternatives, and modifications of embodiments herein. For example, the arrangement of first substrate 902 and second substrate 906 may be interchanged, that is, second substrate 906 may be arranged over first substrate 902.

Article 102, article 202 and article 702 are suitable for use in various applications, where hygroscopic materials are used. Examples of such applications include, but are not limited to, holographic storage media, organic photovoltaic cells, and organic lighting devices.

An embodiment herein provides a storage medium. The storage medium includes a first substrate, a second substrate, one or more first structures at a first periphery, and one or more second structures at a second periphery. The first periphery is associated with the first substrate, while the second periphery is associated with the second substrate. The first structures have a shape that is substantially complementary to the shape of the second structures. The first structures and the second structures are capable of being engaged together mechanically to form an enclosure between the first substrate and the second substrate.

In accordance with an embodiment herein, the first structures include a plurality of first three-dimensional features protruding out from the first substrate along the first periphery in a sequence, and the second structures include a plurality of second three-dimensional features protruding out from the second substrate along the second periphery in a sequence. In order to form the enclosure, the first substrate is aligned with the second substrate, such that the first three-dimensional features and the second three-dimensional features are substantially engaged in an alternating manner.

In accordance with another embodiment herein, the first structures include one or more first threads on a first extension at the first periphery, and the second structures include one or more second threads on a second extension at the second periphery. The first threads and the second threads substantially complement each other. The first substrate is aligned with the second substrate, and rotated relative to the second substrate, such that the first threads and the second threads close together. The first substrate may, for example, be rotated at an angle of rotation ranging between 10 degrees and 360 degrees, to form the enclosure.

A storage material is dispensed between the first substrate and the second substrate. The storage material includes a hygroscopic material. For example, the storage material may be an active material in a fluid state. The active material cures itself and bonds the first substrate and the second substrate together. The enclosure, formed by the first structures and the second structures, prevents exposure of the storage material to the surrounding environment.

The storage medium may be manufactured in any desired shape and size. For example, the storage medium may be made in circular, rectangular or square shapes. In case of a circular storage medium, the storage medium may be made with a diameter ranging between 60 mm and 130 mm.

Another embodiment herein provides a photovoltaic cell. The photovoltaic cell includes a first substrate, a second substrate, one or more first structures at a first periphery, and one or more second structures at a second periphery. The first periphery is associated with the first substrate, while the second periphery is associated with the second substrate. The first structures have a shape that is substantially complementary to the shape of the second structures. The first structures and the second structures are capable of being engaged together mechanically to form an enclosure between the first substrate and the second substrate.

The photovoltaic cell includes one or more photovoltaic elements placed between the first substrate and the second substrate. The photovoltaic elements include a hygroscopic material. The photovoltaic elements may be of any desired shape and size. For example, the photovoltaic elements may be rectangular in shape, and placed substantially parallel to each other. Alternatively, a single photovoltaic element in the form of a sheet may be placed between the first substrate and the second substrate.

The enclosure, formed by the first structures and the second structures, prevents exposure of the hygroscopic material to the surrounding environment.

Yet another embodiment herein provides a lighting device. The lighting device includes a first substrate, a second substrate, one or more first structures at a first periphery, and one or more second structures at a second periphery. The first periphery is associated with the first substrate, while the second periphery is associated with the second substrate. The first structures have a shape that is substantially complementary to the shape of the second structures. The first structures and the second structures are capable of being engaged together mechanically to form an enclosure between the first substrate and the second substrate.

The lighting device includes one or more light-emitting elements placed between the first substrate and the second substrate. The light-emitting elements include a hygroscopic material. The enclosure, formed by the first structures and the second structures, prevents exposure of the hygroscopic material to the surrounding environment.

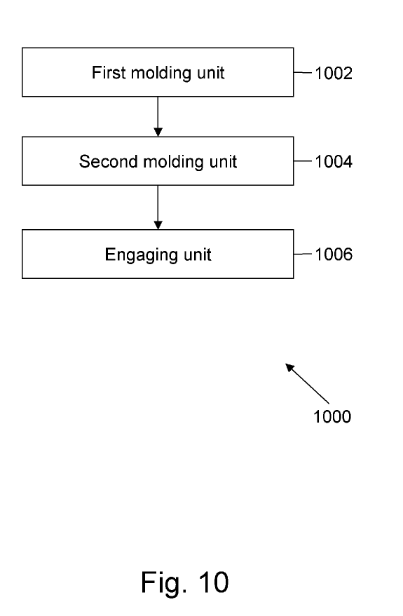

FIG. 10 illustrates a system 1000 for manufacturing an article involving encapsulation of one or more hygroscopic materials, in accordance with an embodiment herein. System 1000 includes a first molding unit 1002, a second molding unit 1004 and an engaging unit 1006.

First molding unit 1002 is adapted to mold a first substrate, and form one or more first structures at a first periphery associated with the first substrate. First molding unit 1002 may, for example, be an injection molding machine adapted to mold a first substrate of a desired shape and size. For example, the first substrate may be made circular in shape.

Second molding unit 1004 is adapted to mold a second substrate, and form one or more second structures at a second periphery associated with the second substrate. Second molding unit 1004 may, for example, be an injection molding machine adapted to mold a second substrate of a desired shape and size. For example, the second substrate may be made circular in shape.

In addition, first molding unit 1002 and second molding unit 1004 are adapted to form the first structures and the second structures, such that the first structures and the second structures substantially complement each other.

Engaging unit 1006 is adapted to engage the first structures and the second structures together mechanically to form an enclosure between the first substrate and the second substrate. As mentioned above, the enclosure is capable of preventing exposure of a hygroscopic material encapsulated between the first substrate and the second substrate to the surrounding environment.

It should be noted that the first substrate and the second substrate may be made from the same manufacturing material or different manufacturing materials, depending on their desired characteristics, such as transparency, strength and flexibility. Examples of manufacturing materials include, but are not limited to, plastics, polypropylene, polystyrene, polycarbonates, and other polymers.

FIG. 10 is merely an example, which should not unduly limit the scope of the claims herein. One of ordinary skill in the art would recognize many variations, alternatives, and modifications of embodiments herein.

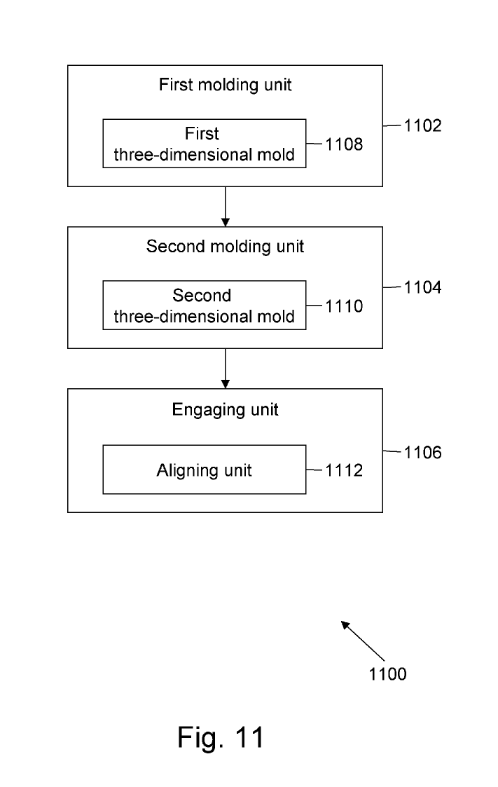

FIG. 11 illustrates a system 1100 for manufacturing an article involving encapsulation of one or more hygroscopic materials, in accordance with another embodiment herein. System 1100 includes a first molding unit 1102, a second molding unit 1104 and an engaging unit 1106.

First molding unit 1102 is adapted to mold a first substrate, and form one or more first structures at a first periphery associated with the first substrate. First molding unit 1102 may, for example, be an injection molding machine adapted to mold a first substrate of a desired shape and size.

First molding unit 1102 includes a first three-dimensional mold 1108 adapted to form a plurality of first three-dimensional features protruding out from the first substrate along the first periphery in a sequence.

Second molding unit 1104 is adapted to mold a second substrate, and form one or more second structures at a second periphery associated with the second substrate. Second molding unit 1104 may, for example, be an injection molding machine adapted to mold a second substrate of a desired shape and size.

Second molding unit 1104 includes a second three-dimensional mold 1110 adapted to form a plurality of second three-dimensional features protruding out from the second substrate along the second periphery in a sequence.

In addition, first three-dimensional mold 1108 and second three-dimensional mold 1110 are adapted to form the first three-dimensional features and the second three-dimensional features, such that the first three-dimensional features and the second three-dimensional features substantially complement each other. The first three-dimensional features and the second three-dimensional features may be formed in any desired shape and size. For example, the first three-dimensional features and the second three-dimensional features may be made polygonal or curved in shape, as shown in FIGS. 3A-3C, 4A-4B, 5A-5B and 6A-6B.

As mentioned above, the first substrate and the second substrate may be made from the same manufacturing material or different manufacturing materials, depending on their desired characteristics, such as transparency, strength and flexibility. Examples of manufacturing materials include, but are not limited to, plastics, polypropylene, polystyrene, polycarbonates, and other polymers.

Engaging unit 1106 is adapted to engage the first structures and the second structures together mechanically to form an enclosure between the first substrate and the second substrate.

Engaging unit 1106 includes an aligning unit 1112. Aligning unit 1112 is adapted to align the first substrate and the second substrate, such that the first three-dimensional features and the second three-dimensional features are substantially engaged in an alternating manner.

Aligning unit 1112 may, for example, be implemented as a pick-and-place unit that picks the first substrate, and aligns the first substrate with the second substrate.

The enclosure so formed is capable of preventing exposure of a hygroscopic material encapsulated between the first substrate and the second substrate to the surrounding environment.

FIG. 11 is merely an example, which should not unduly limit the scope of the claims herein. One of ordinary skill in the art would recognize many variations, alternatives, and modifications of embodiments herein.

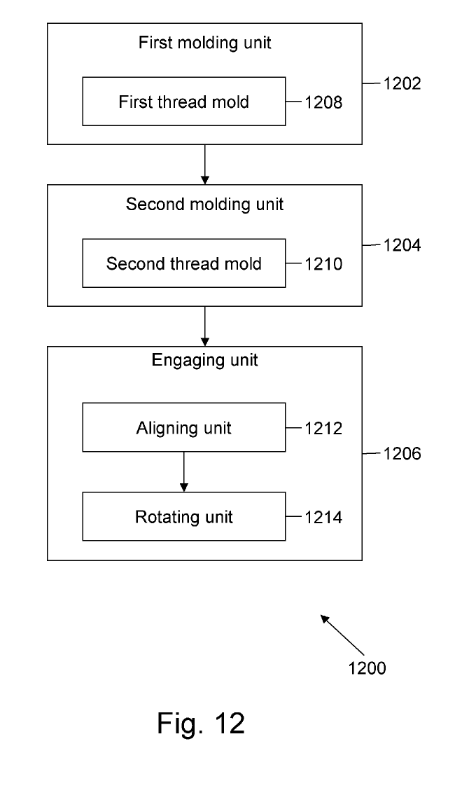

FIG. 12 illustrates a system 1200 for manufacturing an article involving encapsulation of one or more hygroscopic materials, in accordance with yet another embodiment herein. System 1200 includes a first molding unit 1202, a second molding unit 1204 and an engaging unit 1206.

First molding unit 1202 is adapted to mold a first substrate, and form one or more first structures at a first periphery associated with the first substrate. First molding unit 1202 may, for example, be an injection molding machine adapted to mold a first substrate of a desired shape and size.

First molding unit 1202 includes a first thread mold 1208 adapted to form one or more first threads on a first extension at the first periphery.

Second molding unit 1204 is adapted to mold a second substrate, and form one or more second structures at a second periphery associated with the second substrate. Second molding unit 1204 may, for example, be an injection molding machine adapted to mold a second substrate of a desired shape and size.

Second molding unit 1204 includes a second thread mold 1210 adapted to form one or more second threads on a second extension at the second periphery.

In addition, first thread mold 1208 and second thread mold 1210 are adapted to form the first threads and the second threads, such that the first threads and the second threads substantially complement each other. The first threads and the second threads may be formed in any desired manner. For example, the first threads and the second threads may be made on L-shaped extensions on the first substrate and the second substrate, as shown in FIGS. 8A and 8B. Alternatively, the first threads and the second threads may be made as shown in FIGS. 9A and 9B.

As mentioned above, the first substrate and the second substrate may be made from the same manufacturing material or different manufacturing materials, depending on their desired characteristics, such as transparency, strength and flexibility. Examples of manufacturing materials include, but are not limited to, plastics, polypropylene, polystyrene, polycarbonates, and other polymers.

Engaging unit 1206 is adapted to engage the first structures and the second structures together mechanically to form an enclosure between the first substrate and the second substrate.

Engaging unit 1206 includes an aligning unit 1212 and a rotating unit 1214. Aligning unit 1212 is adapted to align the first substrate and the second substrate, while rotating unit 1214 is adapted to rotate the first substrate and the second substrate relative to each other, such that the first threads and the second threads close together.

Aligning unit 1212 may, for example, be implemented as a pick-and-place unit that picks the first substrate, and aligns the first substrate with the second substrate. Rotating unit 1214 may, for example, be a unit that holds the first substrate and the second substrate, and rotates them relative to each other, to form the enclosure. The enclosure so formed is capable of preventing exposure of a hygroscopic material encapsulated between the first substrate and the second substrate to the surrounding environment.

Rotating unit 1214 may, for example, rotate the first substrate and the second substrate relative to each other at an angle of rotation ranging between 10 degrees and 360 degrees. In addition, rotating unit 1214 may be integrated into the pick-and-place unit, wherein the pick-and-place unit may be programmed to rotate the first substrate relative to the second substrate after aligning the first substrate with the second substrate.

FIG. 12 is merely an example, which should not unduly limit the scope of the claims herein. One of ordinary skill in the art would recognize many variations, alternatives, and modifications of embodiments herein.

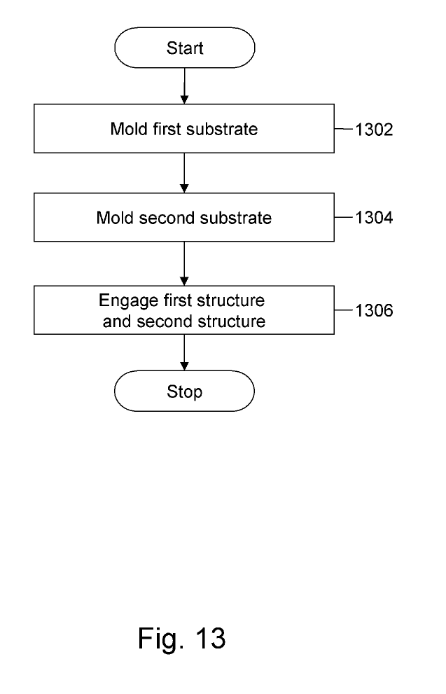

FIG. 13 illustrates a method of manufacturing an article involving encapsulation of one or more hygroscopic materials, in accordance with an embodiment herein. The method is illustrated as a collection of steps in a logical flow diagram, which represents a sequence of steps that can be implemented in hardware, software, or a combination thereof.

At step 1302, a first substrate is molded. One or more first structures are formed at a first periphery associated with the first substrate. Step 1302 may, for example, be performed by an injection molding machine that molds a first substrate of a desired shape and size.

At step 1304, a second substrate is molded. One or more second structures are formed at a second periphery associated with the second substrate. Step 1304 may, for example, be performed by an injection molding machine that molds a second substrate of a desired shape and size. The second substrate is formed in a manner that it substantially complements the first substrate.

At step 1306, the first structures and the second structures are engaged together mechanically to form an enclosure between the first substrate and the second substrate. As mentioned above, the first structures and the second structures substantially complement each other. Consequently, the enclosure, formed by the first structures and the second structures, is capable of preventing exposure of a hygroscopic material encapsulated between the first substrate and the second substrate to the surrounding environment.

It should be noted here that steps 1302-1306 are only illustrative and other alternatives can also be provided where steps are added, one or more steps are removed, or one or more steps are provided in a different sequence without departing from the scope of the claims herein. For example, step 1302 and step 1304 may be performed simultaneously.

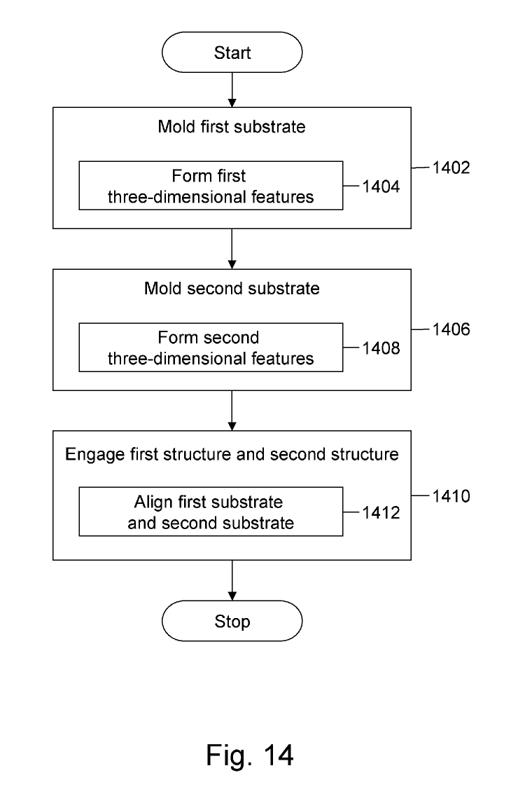

FIG. 14 illustrates a method of manufacturing an article involving encapsulation of one or more hygroscopic materials, in accordance with another embodiment herein. The method is illustrated as a collection of steps in a logical flow diagram, which represents a sequence of steps that can be implemented in hardware, software, or a combination thereof.

At step 1402, a first substrate is molded. One or more first structures are formed at a first periphery associated with the first substrate. Step 1402 includes step 1404 at which a plurality of first three-dimensional features are formed in a sequence. The first three-dimensional features protrude out from the first substrate along the first periphery.

Step 1402 may, for example, be performed by an injection molding machine that molds a first substrate of a desired shape and size. The injection molding machine may, for example, include a first three-dimensional mold that is designed to form the first three-dimensional features on the first substrate. Alternatively, the injection molding machine may include a plurality of three-dimensional molds from which it selects a three-dimensional mold for molding the first substrate.

At step 1406, a second substrate is molded. One or more second structures are formed at a second periphery associated with the second substrate. Step 1406 includes step 1408 at which a plurality of second three-dimensional features are formed in a sequence. The second three-dimensional features protrude out from the second substrate along the second periphery.

Step 1406 may, for example, be performed by an injection molding machine that molds a second substrate of a desired shape and size. The injection molding machine may, for example, include a second three-dimensional mold that is designed to form the second three-dimensional features on the second substrate. Alternatively, the injection molding machine may include a plurality of three-dimensional molds from which it selects a three-dimensional mold for molding the second substrate.

At step 1410, the first structures and the second structures are engaged together mechanically to form an enclosure between the first substrate and the second substrate. Step 1410 includes step 1412. At step 1412, the first substrate and the second substrate are aligned, such that the first three-dimensional features and the second three-dimensional features are substantially engaged in an alternating manner.

Step 1412 may, for example, be performed by a pick-and-place unit that picks the first substrate, and aligns the first substrate with the second substrate.

As mentioned above, the first three-dimensional features and the second three-dimensional features are formed in a manner that they substantially complement each other. Consequently, the enclosure, formed by the first three-dimensional features and the second three-dimensional features, is capable of preventing exposure of a hygroscopic material encapsulated between the first substrate and the second substrate to the surrounding environment.

It should be noted here that steps 1402-1412 are only illustrative and other alternatives can also be provided where steps are added, one or more steps are removed, or one or more steps are provided in a different sequence without departing from the scope of the claims herein. For example, step 1402 and step 1406 may be performed simultaneously.

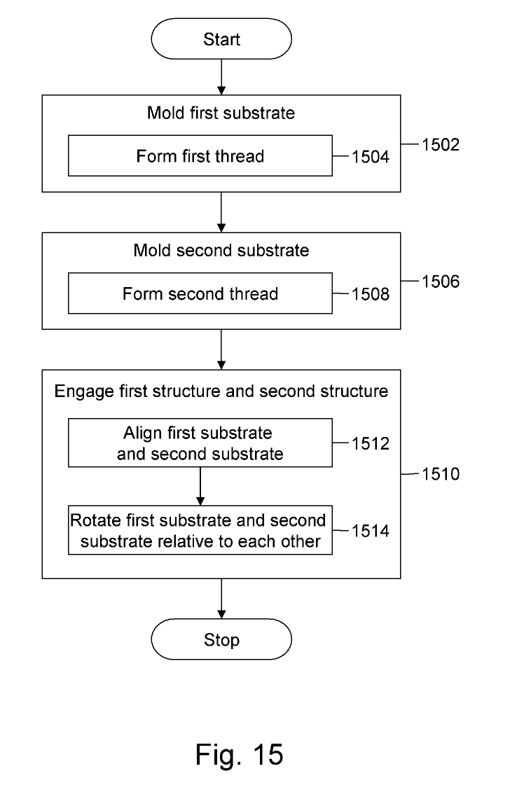

FIG. 15 illustrates a method of manufacturing an article involving encapsulation of one or more hygroscopic materials, in accordance with yet another embodiment herein. The method is illustrated as a collection of steps in a logical flowdiagram, which represents a sequence of steps that can be implemented in hardware, software, or a combination thereof.

At step 1502, a first substrate is molded. One or more first structures are formed at a first periphery associated with the first substrate. Step 1502 includes step 1504 at which one or more first threads are formed on a first extension at the first periphery.

Step 1502 may, for example, be performed by an injection molding machine that molds a first substrate of a desired shape and size. The injection molding machine may, for example, include a first thread mold that is designed to form the first threads on the first substrate. Alternatively, the injection molding machine may include a plurality of thread molds from which it selects a thread mold for molding the first substrate.

At step 1506, a second substrate is molded. One or more second structures are formed at a second periphery associated with the second substrate. Step 1506 includes step 1508 at which one or more second threads are formed on a second extension at the second periphery.

Step 1506 may, for example, be performed by an injection molding machine that molds a second substrate of a desired shape and size. The injection molding machine may, for example, include a second thread mold that is designed to form the second threads on the second substrate. Alternatively, the injection molding machine may include a plurality of thread molds from which it selects a thread mold for molding the second substrate.

At step 1510, the first structures and the second structures are engaged together mechanically to form an enclosure between the first substrate and the second substrate. Step 1510 includes step 1512 and step 1514. At step 1512, the first substrate and the second substrate are aligned. Next, at step 1514, the first substrate and the second substrate are rotated relative to each other, such that the first threads and the second threads close together.

Step 1512 may, for example, be performed by a pick-and-place unit that picks the first substrate, and aligns the first substrate with the second substrate. Step 1514 may, for example, be then performed by a rotating unit that holds the first substrate and the second substrate, and rotates them relative to each other.

As mentioned above, the first threads and the second threads are formed in a manner that they substantially complement each other. Consequently, the enclosure, formed by the first threads and the second threads, is capable of preventing exposure of a hygroscopic material encapsulated between the first substrate and the second substrate to the surrounding environment.

It should be noted here that steps 1502-1514 are only illustrative and other alternatives can also be provided where steps are added, one or more steps are removed, or one or more steps are provided in a different sequence without departing from the scope of the claims herein. For example, step 1502 and step 1506 may be performed simultaneously.

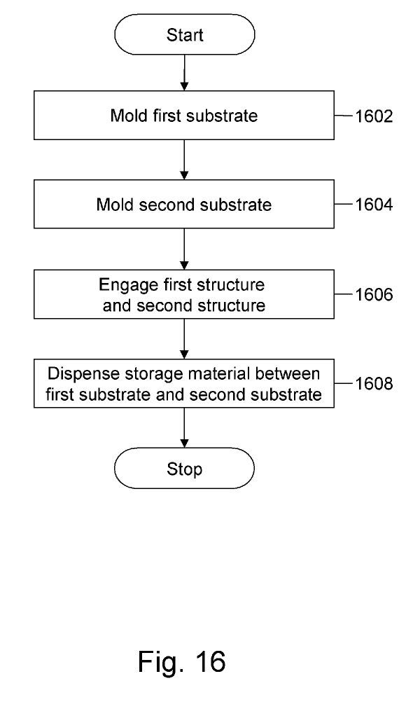

FIG. 16 illustrates a method of manufacturing a storage medium, in accordance with an embodiment herein. The method is illustrated as a collection of steps in a logical flow diagram, which represents a sequence of steps that can be implemented in hardware, software, or a combination thereof.

At step 1602, a first substrate is molded. One or more first structures are formed at a first periphery associated with the first substrate. Step 1602 may, for example, be performed by an injection molding machine that molds a first substrate of a desired shape and size. The storage medium may, for example, be a holographic storage medium that is circular in shape. In such a case, a circular first substrate is molded.

At step 1604, a second substrate is molded. One or more second structures are formed at a second periphery associated with the second substrate. Step 1604 may, for example, be performed by an injection molding machine that molds a second substrate of a desired shape and size. The second substrate is formed in a manner that it substantially complements the first substrate.

At step 1606, the first structures and the second structures are engaged together mechanically to form an enclosure between the first substrate and the second substrate.

At step 1608, a storage material is dispensed between the first substrate and the second substrate. The storage material includes a hygroscopic material. For example, the storage material may be an active material in a fluid state. The active material cures itself and bonds the first substrate and the second substrate together. The enclosure, formed by the first structures and the second structures, prevents exposure of the storage material to the surrounding environment.

It should be noted here that steps 1602-1608 are only illustrative and other alternatives can also be provided where steps are added, one or more steps are removed, or one or more steps are provided in a different sequence without departing from the scope of the claims herein. For example, step 1602 and step 1604 may be performed simultaneously.

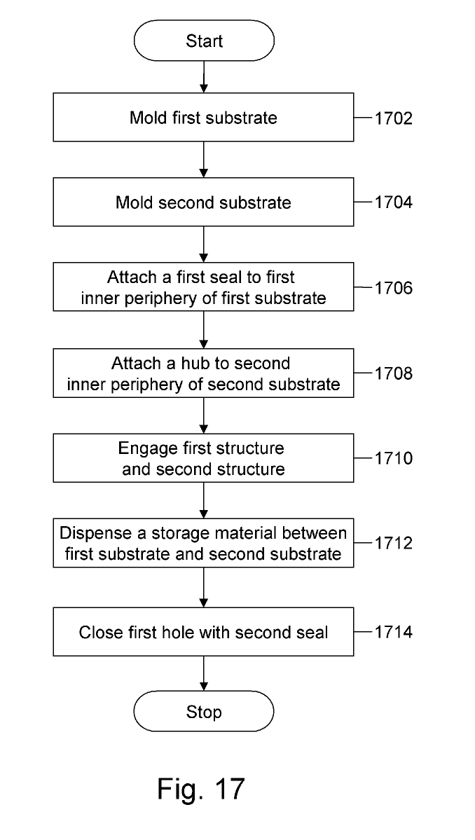

FIG. 17 illustrates a method of manufacturing a storage medium, in accordance with another embodiment herein. The method is illustrated as a collection of steps in a logical flow diagram, which represents a sequence of steps that can be implemented in hardware, software, or a combination thereof.

At step 1702, a first substrate is molded. Step 1702 may, for example, be performed by an injection molding machine that molds a first substrate of a desired shape and size. The storage medium may, for example, be a holographic storage medium that is circular in shape and has a central punch area. In such a case, a circular first substrate with a central punch area is molded. The first substrate so molded includes a first inner periphery and a first outer periphery. One or more first structures are formed at the first outer periphery, in accordance with step 1702.

At step 1704, a second substrate is molded. Step 1704 may, for example, be performed by an injection molding machine that molds a second substrate of a desired shape and size. The second substrate is formed in a manner that it substantially complements the first substrate. Therefore, the second substrate also includes a second inner periphery and a second outer periphery. One or more second structures are formed at the second outer periphery, in accordance with step 1704.

As mentioned above, the first substrate and the second substrate may be made from the same manufacturing material or different manufacturing materials, depending on their desired characteristics, such as transparency, strength and flexibility. Examples of manufacturing materials include, but are not limited to, plastics, polypropylene, polystyrene, polycarbonates, and other polymers.

At step 1706, a first seal is attached to the first inner periphery of the first substrate. The first seal includes a first hole.

At step 1708, a hub is attached to the second inner periphery of the second substrate. The hub may, for example, be in the form of a metal disc. This facilitates fitting of a rotating chuck of an optical drive into the hub, and helps in holding the storage medium.

At step 1710, the first structures and the second structures are engaged together mechanically to form an enclosure between the first substrate and the second substrate.

In accordance with an embodiment herein, the first structures and the second structures may be in the form of a plurality of three-dimensional features. In such a case, the first substrate is aligned with the second substrate, such that the three-dimensional features of the first substrate and the second substrate are substantially engaged in an alternating manner. In accordance with another embodiment herein, the first structures and the second structures may be in the form of threads. In such a case, the first substrate is aligned with the second substrate, and the first substrate and the second substrate are rotated relative to each other, such that their threads close together.

As mentioned above, a three-dimensional space is left between the first substrate and the second substrate. At step 1712, a storage material is dispensed between the first substrate and the second substrate, through the first hole on the first seal. The storage material includes a hygroscopic material. For example, the storage material may be an active material in a fluid state. The active material fills the space between the first substrate and the second substrate. The active material then cures itself and bonds the first substrate and the second substrate together.

At step 1714, the first hole is closed with a second seal. The second seal may, for example, be a hermetic seal.

As mentioned above, the enclosure, formed by the first structures and the second structures, prevents exposure of the storage material to the surrounding environment.

The storage medium so formed may also be packed in a cartridge assembly in order to protect the storage medium from external factors, such as heat, moisture and radiation.

It should be noted here that steps 1702-1714 are only illustrative and other alternatives can also be provided where steps are added, one or more steps are removed, or one or more steps are provided in a different sequences without departing from the scope of the claims herein. For example, step 1702 and step 1704 may be performed simultaneously. In addition, the steps of depositing one or more layers of an anti-reflection coating on the first substrate and/or the second substrate may be added.

One or more of the following steps may be added: the step of mastering a solid metallic plate to design a first stamper that is capable of molding the first substrate with the first structures, and the step of mastering another solid metallic plate to design a second stamper that is capable of molding the second substrate with the second structures. The solid metallic plates may, for example, be made of nickel. The first stamper and the second stamper may, for example, be used in the injection molding machines at step 1702 and step 1704, respectively.

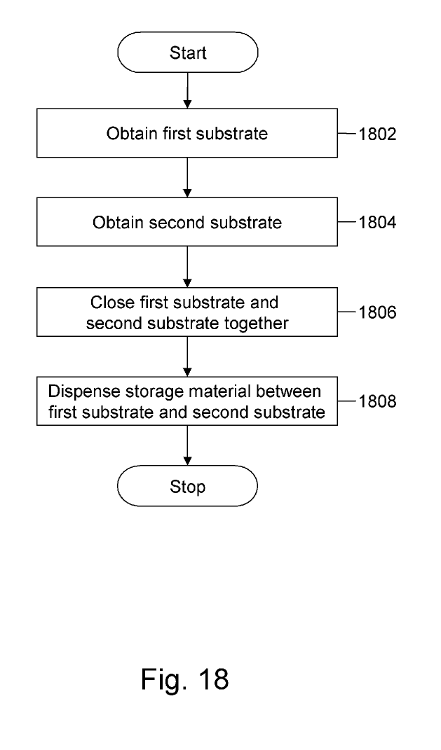

FIG. 18 illustrates a method of manufacturing a storage medium, in accordance with yet another embodiment herein. The method is illustrated as a collection of steps in a logical flow diagram, which represents a sequence of steps that can be implemented in hardware, software, or a combination thereof.

At step 1802, a first substrate is obtained. One or more first structures are formed at a first periphery associated with the first substrate. Step 1802 may, for example, be performed in a manner that is similar to step 1402 or step 1502 described earlier.

At step 1804, a second substrate is obtained. One or more second structures are formed at a second periphery associated with the second substrate. Step 1804 may, for example, be performed in a manner that is similar to step 1406 or step 1506 described earlier.

The storage medium may, for example, be a holographic storage medium that is circular in shape. In such a case, a circular first substrate and a circular second substrate may be obtained.

At step 1806, the first substrate and the second substrate are closed together. In accordance with step 1806, the first structures and the second structures are engaged together mechanically to form an enclosure between the first substrate and the second substrate. Step 1806 may, for example, be performed in a manner that is similar to step 1410 or step 1510 described earlier.

At step 1808, a storage material is dispensed between the first substrate and the second substrate. The storage material includes a hygroscopic material. For example, the storage material may be an active material in a fluid state. The active material cures itself and bonds the first substrate and the second substrate together. The enclosure, formed by the first structures and the second structures, prevents exposure of the storage material to the surrounding environment.

It should be noted here that steps 1802-1808 are only illustrative and other alternatives can also be provided where steps are added, one or more steps are removed, or one or more steps are provided in a different sequence without departing from the scope of the claims herein. For example, step 1802 and step 1804 may be performed simultaneously.

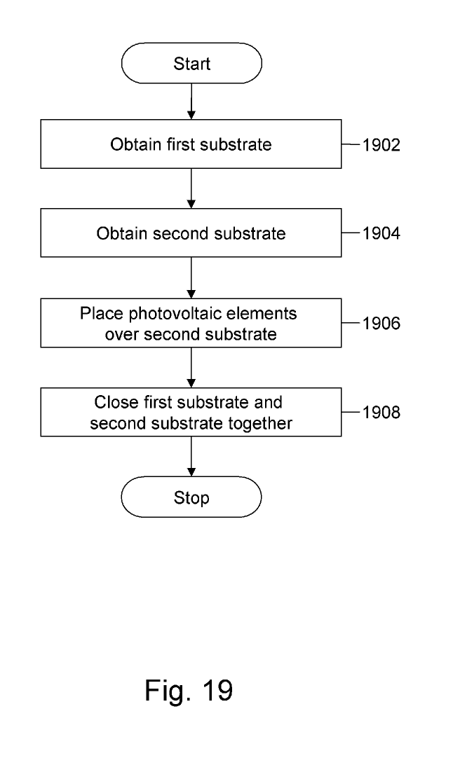

FIG. 19 illustrates a method of manufacturing a photovoltaic cell, in accordance with an embodiment herein. The method is illustrated as a collection of steps in a logical flow diagram, which represents a sequence of steps that can be implemented in hardware, software, or a combination thereof.

At step 1902, a first substrate is obtained. One or more first structures are formed at a first periphery associated with the first substrate. Step 1902 may, for example, be performed in a manner that is similar to step 1402 or step 1502 described earlier.

At step 1904, a second substrate is obtained. One or more second structures are formed at a second periphery associated with the second substrate. Step 1904 may, for example, be performed in a manner that is similar to step 1406 or step 1506 described earlier.

The photovoltaic cell may, for example, be an organic photovoltaic cell that is rectangular in shape. In such a case, a rectangular first substrate and a rectangular second substrate may be obtained.

At step 1906, one or more photovoltaic elements are placed over the second substrate. The photovoltaic elements may be of any desired shape and size. For example, the photovoltaic elements may be rectangular in shape, and placed substantially parallel to each other. Alternatively, a single photovoltaic element in the form of a sheet may be placed on the second substrate.

At step 1908, the first substrate and the second substrate are closed together. In accordance with step 1908, the first structures and the second structures are engaged together mechanically to form an enclosure between the first substrate and the second substrate. Step 1908 may, for example, be performed in a manner that is similar to step 1410 or step 1510 described earlier.

A sealant may be applied on the first structures and the second structures, so that the first substrate and the second substrate are bonded together.

The photovoltaic elements include a hygroscopic material. The enclosure so formed prevents exposure of the hygroscopic material to the surrounding environment.

It should be noted here that steps 1902-1908 are only illustrative and other alternatives can also be provided where steps are added, one or more steps are removed, or one or more steps are provided in a different sequence without departing from the scope of the claims herein. For example, step 1902 and step 1904 may be performed simultaneously.

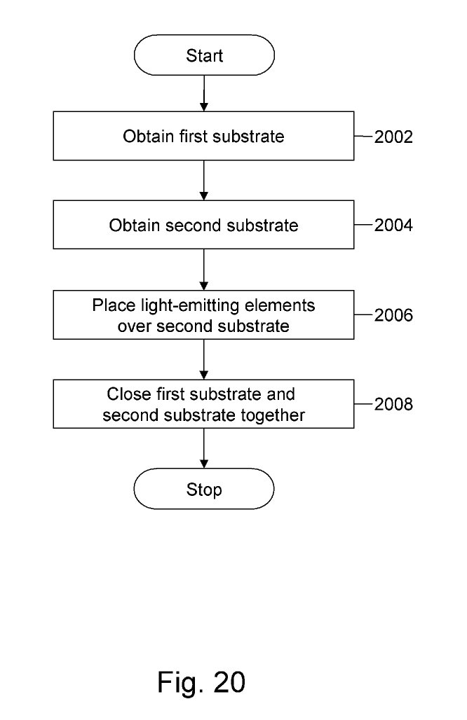

FIG. 20 illustrates a method of manufacturing a lighting device, in accordance with an embodiment herein. The method is illustrated as a collection of steps in a logical flow diagram, which represents a sequence of steps that can be implemented in hardware, software, or a combination thereof.

At step 2002, a first substrate is obtained. One or more first structures are formed at a first periphery associated with the first substrate. Step 2002 may, for example, be performed in a manner that is similar to step 1402 or step 1502 described earlier.

At step 2004, a second substrate is obtained. One or more second structures are formed at a second periphery associated with the second substrate. Step 2004 may, for example, be performed in a manner that is similar to step 1406 or step 1506 described earlier.

The lighting device may, for example, be an organic lighting device that is rectangular in shape. In such a case, a rectangular first substrate and a rectangular second substrate may be obtained.

At step 2006, one or more light-emitting elements are placed over the second substrate.

Subsequently, at step 2008, the first substrate and the second substrate are closed together. In accordance with step 2008, the first structures and the second structures are engaged together mechanically to form an enclosure between the first substrate and the second substrate. Step 2008 may, for example, be performed in a manner that is similar to step 1410 or step 1510 described earlier.

A sealant may be applied on the first structures and the second structures, so that the first substrate and the second substrate are bonded together.

The light-emitting elements include a hygroscopic material. The enclosure so formed prevents exposure of the hygroscopic material to the surrounding environment.

It should be noted here that steps 2002-2008 are only illustrative and other alternatives can also be provided where steps are added, one or more steps are removed, or one or more steps are provided in a different sequence without departing from the scope of the claims herein. For example, step 2002 and step 2004 may be performed simultaneously.

Embodiments herein provide an article involving encapsulation of one or more hygroscopic materials. A first substrate and a second substrate with first structures and second structures, respectively, are molded. The first structures and the second structures are then engaged together mechanically to form an enclosure between the first substrate and the second substrate.

The first structures and the second structures are simple in form, and can be engaged together to form the enclosure in a simple manner. Therefore, the article can be manufactured with higher yield in lesser time, compared to conventional articles.

In addition, the enclosure so formed is reliable, and therefore, is capable of preventing exposure of a hygroscopic material encapsulated between the first substrate and the second substrate to the surrounding environment.

Further, no additional material is required to be applied to form the enclosure. Therefore, the article has a reduced dead weight, and has a low cost, compared to conventional articles.

Moreover, an additional side wrap may be applied on the article, if required.

Furthermore, the article is suitable for various applications, including, but not limited to, holographic storage media, organic photovoltaic cells, and organic lighting devices.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. An article of manufacture involving encapsulation of one or more hygroscopic materials, said article comprising:
a first substrate;
a second substrate;
one or more first structures at a first periphery, said first periphery being associated with said first substrate; and
one or more second structures at a second periphery, said second periphery being associated with said second substrate,
wherein said first structures and said second structures substantially complement each other, said first structures and said second structures are capable of being engaged together mechanically to form an enclosure between said first substrate and said second substrate, said enclosure being capable of preventing exposure of a hygroscopic material encapsulated between said first substrate and said second substrate to surrounding environment.

2. The article of claim 1, wherein said first structures comprise a plurality of first three-dimensional features protruding out from said first substrate, along said first periphery in a sequence, said second structures comprise a plurality of second three-dimensional features protruding out from said second substrate, along said second periphery in a sequence, and said first substrate is aligned with said second substrate, such that said first three-dimensional features and said second three-dimensional features are substantially engaged in an alternating manner.

3. The article of claim 1, wherein said first structures comprise one or more first threads on a first extension at said first periphery, said second structures comprise one or more second threads on a second extension at said second periphery, said first substrate is aligned with said second substrate, and said first substrate and said second substrate are rotated relative to each other, such that said first threads and said second threads close together.

4. The article of claim 1 further comprising a storage material dispensed between said first substrate and said second substrate, said storage material comprising a hygroscopic material, said enclosure preventing exposure of said hygroscopic material to surrounding environment.

5. The article of claim 1 is a holographic storage medium.

6. The article of claim 1 further comprising one or more photovoltaic elements placed between said first substrate and said second substrate, said photovoltaic elements comprising a hygroscopic material, said enclosure preventing exposure of said hygroscopic material to surrounding environment.

7. The article of claim 1 further comprising one or more light-emitting elements placed between said first substrate and said second substrate, said light-emitting elements comprising a hygroscopic material, said enclosure preventing exposure of said hygroscopic material to surrounding environment.

8. A method of manufacturing an article involving encapsulation of one or more hygroscopic materials, the method comprising:
molding a first substrate, wherein one or more first structures are formed at a first periphery associated with said first substrate;
molding a second substrate, wherein one or more second structures are formed at a second periphery associated with said second substrate, said second structures substantially complementing said first structures; and
engaging said first structures and said second structures together mechanically to form an enclosure between said first substrate and said second substrate, said enclosure being capable of preventing exposure of a hygroscopic material encapsulated between said first substrate and said second substrate to surrounding environment.

9. The method of claim 8, wherein said molding said first substrate comprises forming a plurality of first three-dimensional features in a sequence, said first three-dimensional features protruding out from said first substrate along said first periphery, said molding said second substrate comprises forming a plurality of second three-dimensional features in a sequence, said second three-dimensional features protruding out from said second substrate along said second periphery, and said engaging comprises aligning said first substrate and said second substrate, such that said first three-dimensional features and said second three-dimensional features are substantially engaged in an alternating manner.

10. The method of claim 8, wherein said molding said first substrate comprises forming one or more first threads on a first extension at said first periphery, said molding said second substrate comprises forming one or more second threads on a second extension at said second periphery, and said engaging comprises:
aligning said first substrate and said second substrate; and
rotating said first substrate and said second substrate relative to each other, such that said first threads and said second threads close together.

11. The method of claim 8 further comprising dispensing a storage material between said first substrate and said second substrate, said storage material comprising a hygroscopic material, wherein said enclosure prevents exposure of said hygroscopic material to surrounding environment.

12. The method of claim 11 further comprising:
attaching a first seal to a first inner periphery associated with said first substrate, said first seal comprising a first hole; and
attaching a hub to a second inner periphery associated with said second substrate.

13. The method of claim 12, wherein said storage material is dispensed between said first substrate and said second substrate through said first hole.

14. The method of claim 12 further comprising closing said first hole with a second seal.

15. The method of claim 8 further comprising placing one or more photovoltaic elements between said first substrate and said second substrate, wherein said photovoltaic elements comprise a hygroscopic material, said enclosure preventing exposure of said hygroscopic material to surrounding environment.

16. The method of claim 8 further comprising placing one or more light-emitting elements between said first substrate and said second substrate, wherein said light-emitting elements comprise a hygroscopic material, said enclosure preventing exposure of said hygroscopic material to surrounding environment.

17. A storage medium comprising:
a first substrate;
a second substrate;
one or more first structures at a first periphery, said first periphery being associated with said first substrate;
one or more second structures at a second periphery, said second periphery being associated with said second substrate, wherein said first structures and said second structures substantially complement each other, said first structures and said second structures are capable of being engaged together mechanically to form an enclosure between said first substrate and said second substrate; and
a storage material dispensed between said first substrate and said second substrate, said storage material comprising a hygroscopic material, wherein said enclosure prevents exposure of said hygroscopic material to surrounding environment.

18. The storage medium of claim 17, wherein said first structures comprise a plurality of first three-dimensional features protruding out from said first substrate, along said first periphery in a sequence, said second structures comprise a plurality of second three-dimensional features protruding out from said second substrate, along said second periphery in a sequence, and said first substrate is aligned with said second substrate, such that said first three-dimensional features and said second three-dimensional features are substantially engaged in an alternating manner.

19. The storage medium of claim 17, wherein said first structures comprise one or more first threads on a first extension at said first periphery, said second structures comprise one or more second threads on a second extension at said second periphery, said first substrate is aligned with said second substrate, and said first substrate and said second substrate are rotated relative to each other, such that said first threads and said second threads close together.

20. The storage medium of claim 17 is a holographic storage medium.
